(19) United States
(12) Patent Application Publication
(10) Pub. No.: US 2022/0287127 A1
(43) Pub. Date: Sep. 8, 2022

(54) PREVENTING DATA OUTAGE FOR USER EQUIPMENT DURING E-UTRAN NEW RADIO DUAL CONNECTIVITY PROCEDURE

(71) Applicant: Nokia Solutions Networks Oy, Espoo (FI)

(72) Inventors: Badrinath ROKKAPPANAVARA, Bangalore (IN); Mallikarjuna Honnashettyhalli BORALINGEGOWDA, Bangalore (IN); Santhosh BGPURA NANJUNDASWAMY, Bangalore (IN); Krzysztof KORDYBACH, Pulawy (PL)

(21) Appl. No.: 17/669,245

(22) Filed: Feb. 10, 2022

(30) Foreign Application Priority Data
Mar. 2, 2021 (IN) 202141008774

(51) Int. Cl. H04W 76/16; H04W 76/12; H04W 76/30; H04W 76/19

(52) U.S. Cl. CPC H04W 76/16; H04W 76/12; H04W 76/30; H04W 76/19

(57) ABSTRACT

Systems, methods, apparatuses, and computer program products for preventing data outage for user equipment (UE) during Evolved Universal Mobile Telecommunications System Terrestrial Radio Access Network (E-UTRAN) New Radio Dual Connectivity (EN-DC). The method may include identifying a status of a user plane path between a first network node and a gateway node in a communication network. The method may also include transmitting, to a second network node, the status of the user plane path. The method may further include setting up or disconnecting a connection between the first network node and the second network node during a dual connectivity operation.

### CROSS REFERENCE TO RELATED APPLICATIONS:

This application claims priority from IN Provisional Application No. 202141008774, filed on Mar. 2, 2021. The entire contents of this earlier filed application are hereby incorporated by reference in their entirety.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain example embodiments may relate to apparatuses, systems, and/or methods for preventing data outage for user equipment (UE) during Evolved Universal Mobile Telecommunications System Terrestrial Radio Access Network (E-UTRAN) New Radio Dual Connectivity (EN-DC).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G is mostly built on a new radio (NR), but the 5G (or NG) network can also build on E-UTRAN radio. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) are named gNB when built on NR radio and named NG-eNB when built on E-UTRAN radio.

### SUMMARY

Some example embodiments may be directed to a method. The method may include identifying a status of a user plane path between a first network node and a gateway node in a communication network. The method may also include transmitting, to a second network node, the status of the user plane path. The method may further include setting up or disconnecting a connection between the first network node and the second network node during a dual connectivity operation.

Other example embodiments may be directed to an apparatus. The apparatus may include at least one processor and at least one memory including computer program code. The at least one memory and computer program code may also be configured to, with the at least one processor, cause the apparatus at least to identify a status of a user plane path between the apparatus and a gateway node in a communication network. The apparatus may also be caused to transmit, to a network node, the status of the user plane path. The apparatus may further be caused to setup or disconnect a connection between the apparatus and the network node during a dual connectivity operation.

Other example embodiments may be directed to an apparatus. The apparatus may include means for identifying a status of a user plane path between the apparatus and a gateway node in a communication network. The apparatus may also include means for transmitting, to a network node, the status of the user plane path. The apparatus may further include means for setting up or disconnecting a connection between the apparatus and the network node during a dual connectivity operation.

In accordance with other example embodiments, a non-transitory computer readable medium may be encoded with instructions that may, when executed in hardware, perform a method. The method may include identifying a status of a user plane path between a first network node and a gateway node in a communication network. The method may also include transmitting, to a second network node, the status of the user plane path. The method may further include setting up or disconnecting a connection between the first network node and the second network node during a dual connectivity operation.

Other example embodiments may be directed to a computer program product that performs a method. The method may include identifying a status of a user plane path between a first network node and a gateway node in a communication network. The method may also include transmitting, to a second network node, the status of the user plane path. The method may further include setting up or disconnecting a connection between the first network node and the second network node during a dual connectivity operation.

Other example embodiments may be directed to an apparatus that may include circuitry configured to identify a status of a user plane path between the apparatus and a gateway node in a communication network. The apparatus may also include circuitry configured to transmit, to a network node, the status of the user plane path. The apparatus may further include circuitry configured to setup or disconnect a connection between the apparatus and the network node during a dual connectivity operation.

Some example embodiments may be directed to a method. The method may include triggering a first network node selection in a dual connectivity operation. The method may also include retrieving a status of a user plane path of the first network node. The method may further include, based on the received status, setting up the dual connectivity operation to establish a dual connectivity connection between a second network node and the first network node, or determining whether an alternate network node is available. The method may also include, based on the received status, triggering release of the dual connectivity operation to the first network node.

Other example embodiments may be directed to an apparatus. The apparatus may include at least one processor and at least one memory including computer program code. The at least one memory and computer program code may also be configured to, with the at least one processor, cause the apparatus at least to trigger a network node selection in a dual connectivity operation. The apparatus may also be caused to retrieve a status of a user plane path of the network node. The apparatus may further be caused to, based on the received status, setup the dual connectivity operation to establish a dual connectivity connection between the network node and the apparatus, or determine whether an alternate network node is available. In addition, the apparatus may be caused to, based on the received status, trigger release of the dual connectivity operation to the network node.

Other example embodiments may be directed to an apparatus. The apparatus may include means for triggering a network node selection in a dual connectivity operation. The apparatus may also include means for retrieving a status of a user plane path of the network node. The apparatus may also include means for, based on the received status, setting up the dual connectivity operation to establish a dual connectivity connection between the network node and the apparatus, or determining whether an alternate network node is available. The apparatus may further include means for, based on the received status, triggering release of the dual connectivity operation to the network node.

In accordance with other example embodiments, a non-transitory computer readable medium may be encoded with instructions that may, when executed in hardware, perform a method. The method may include triggering a first network node selection in a dual connectivity operation. The method may also include retrieving a status of a user plane path of the first network node. The method may further include, based on the received status, setting up the dual connectivity operation to establish a dual connectivity connection between a second network node and the first network node, or determining whether an alternate network node is available. The method may also include, based on the received status, triggering release of the dual connectivity operation to the first network node.

Other example embodiments may be directed to a computer program product that performs a method. The method may include triggering a first network node selection in a dual connectivity operation. The method may also include retrieving a status of a user plane path of the first network node. The method may further include, based on the received status, setting up the dual connectivity operation to establish a dual connectivity connection between a second network node and the first network node, or determining whether an alternate network node is available. The method may also include, based on the received status, triggering release of the dual connectivity operation to the first network node.

Other example embodiments may be directed to an apparatus that may include circuitry configured to trigger a network node selection in a dual connectivity operation. The apparatus may also include circuitry configured to retrieve a status of a user plane path of the network node. The apparatus may further include circuitry configured to, based on the received status, setup the dual connectivity operation to establish a dual connectivity connection between the network node and the apparatus, or determine whether an alternate network node is available. The apparatus may further include means for, based on the received status, trigger release of the dual connectivity operation to the network node.

### BRIEF DESCRIPTION OF THE DRAWINGS

For proper understanding of example embodiments, reference should be made to the accompanying drawings, wherein:

FIG. 1(a) illustrates an example of a successful user equipment (UE) data connectivity during an Evolved Universal Mobile Telecommunications System Terrestrial Radio Access Network (E-UTRAN) New Radio Dual Connectivity (EN-DC) procedure.

FIG. 1(b) illustrates an example of data outage at the UE due to S1/NG user plane interface (S1-U/NG-U) path failure during an EN-DC procedure.

FIG. 2 illustrates an example of a network topology and S1-U/NG-U path status table at a master node/MeNB, according to certain example embodiments.

FIG. 3 illustrates an example of a secondary node/en-gNB/SgNB selection logic with additional selection criteria, according to certain example embodiments.

FIG. 4 illustrates an example gNB status indication procedure, according to certain example embodiments.

FIG. 5 illustrates an example flow diagram of a method, according to certain example embodiments.

FIG. 6 illustrates an example flow diagram of another method, according to certain example embodiments.

FIG. 7(a) illustrates an apparatus, according to certain example embodiments.

FIG. 7(b) illustrates another apparatus, according to certain example embodiments.

### DETAILED DESCRIPTION:

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for preventing data outage for user equipment (UE) during Evolved Universal Mobile Telecommunications System Terrestrial Radio Access Network (E-UTRAN) New Radio Dual Connectivity (EN-DC).

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Additionally, “MeNB” may be interchangeably used as “master node” or “master node/MeNB”, or individually used as “MeNB” and “master node”. “MeNB” may also have an equivalent meaning as “master node”. Further “en-gNB/SgNB” may be interchangeably used as “secondary node/en-gNB/SgNB”, or individually used as “secondary node”, “en-gNB” or “SgNB”. Additionally, “secondary node”, “en-gNB”, and SgNB may have an equivalent meaning. Furthermore, “S1-U” may be interchangeably used as “S1-U”, “NG-U”, or “S1-U/NG-U”, or individually used as “S1-U”, “NG-U”, or “S1-U/NG-U”. Each of “S1-U” and “NG-U” may also have an equivalent meaning.

In some cases, general packet radio service (GPRS) tunneling protocol for user plane (GTP-U) failure may arise due to switch/router upgradation, or intermediate hardware failure (switch/router) in an IP network, which sometimes need operator intervention to restore it back to stock. 3^{rd} Generation Partnership Project (3GPP) describes GTP-U path failure handling at the access network and core network, respectively. For example, 3GPP describes, for path failure, a node detecting the GTP-U path failure with its peer may notify the upper layer of the path failure so that the user equipment (UE) can be disconnected from the network, and can retry the attach procedure. 3GPP also describes path failure in the serving gateway (SGW) and the mobility management entity (MME). For example, the SGW may detect the GTP-U path failure with its peer and notify the MME. The MME may in turn allocate another SGW for the bearer or release the bearer. Furthermore, the MME may derive the S1-U/NG-U path information (e.g., the eNB fully qualified tunnel endpoint identifier (F-TEID) and the SGW F-TEID) from the UE context, and mark it as failed. In addition, the MME may store such information for a configurable period. The MME may also avoid selecting the SGW with a failed S1-U/NG-U path towards the eNB for subsequent packet data network (PDN) connection establishment procedures and mobility procedures with SGW relocation.

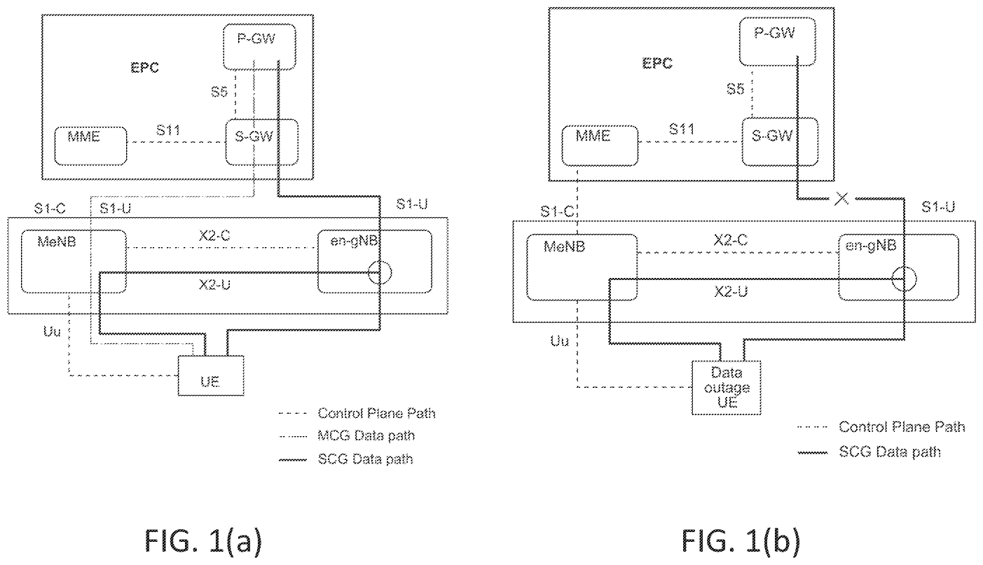

FIG. 1(a) illustrates an example of a successful UE data connectivity during an EN-DC procedure, and FIG. 1(b) illustrates an example of data outage at the UE due to S1-U/NG-U path failure during an EN-DC procedure. In certain cases, during an EN-DC procedure, the MME may select the SGW based on the path status between the master node/MeNB and the SGW. However, in other cases, the MME may not consider the path status between the secondary node/en-gNB/SgNB and the SGW since the secondary node/en-gNB/SgNB selection logic resides at the master node/MeNB. If in case the GTP-U path status between the secondary node/en-gNB/SgNB and the SGW is not reachable, the UE may still successfully attach to the network, and as a result, no radio link failures are detected. In such a case, the attached UE may experience data outage until the GTP-U path is restored. In addition, the radio resource control (RRC) re-establishment or re-attach procedure may result in data outage if the GTP-U path is not restored as the same entities may be allocated again.

According to certain example embodiments, when the GTP-U path failure is identified by the secondary node/en-gNB/SgNB, the status may be indicated to the master node/MeNB. Based on the received path status, the master node/MeNB may avoid the selection of such paths (e.g., en-gNB SGW pair) experiencing the path failure for a secondary gNodeB (SgNB) addition procedure. As such, the UE with dual connectivity capability may not have a secondary cell group (SCG) bearer established involving the path having the failure. Accordingly, it may be possible to avoid experiencing data outage due to the broken link.

In certain example embodiments, to indicate the status of the path failure, the secondary node/en-gNB/SgNB may adapt the existing “gNB Status Indication Message” to update the peer master node/MeNB. Alternatively, in other example embodiments, the secondary node/en-gNB/SgNB may introduce a new message to indicate the status to all the master nodes/MeNBs to which it has X2 setup successfully. According to certain example embodiments, by maintaining the status of the paths between the secondary node/en-gNB/SgNB and SGWs, the master node/MeNB can select an alternative secondary node/en-gNB/SgNB that does not have any connectivity issues with the SGW provided by the MME. According to other example embodiments, the master node/MeNB may request for a different SGW from the MME when there are no alternate secondary nodes/en-gNBs/SgNBs available.

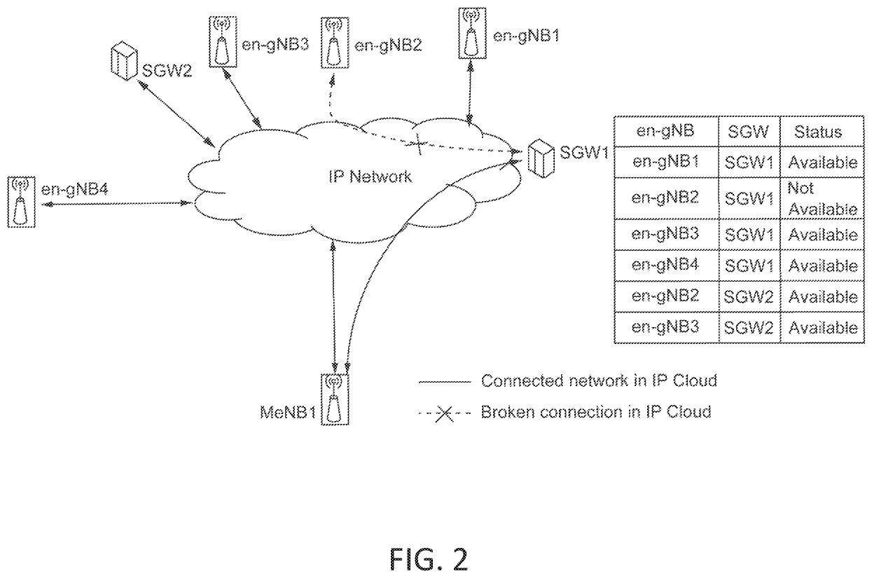

FIG. 2 illustrates an example of a network topology and S1-U/NG-U path status table at the master node/MeNB, according to certain example embodiments. In particular, FIG. 2 illustrates an example of a network deployment where the eNB, secondary node/en-gNB/SgNB, and SGW are connected via an IP network. According to certain example embodiments, the master node/MeNB may maintain connectivity status information as shown in table 200 of FIG. 2. Specifically, the table 200 includes the S1-U/NG-U path status for all the peer secondary nodes/en-gNBs/SgNBs of the master node/MeNB.

In certain example embodiments, the master node/MeNB may receive the status of the paths from the secondary node/en-gNB/SgNB peers through various mechanisms. For example, in some example embodiments, the master node/MeNB may receive status of the paths from secondary node/en-gNB/SgNB peers via an adapted gNB status indication message. In other example embodiments, the master node/MeNB may receive status of the paths from secondary node/en-gNB/SgNB peers via a GTP-U status indication message, which may be a unicast message or a broadcast message.

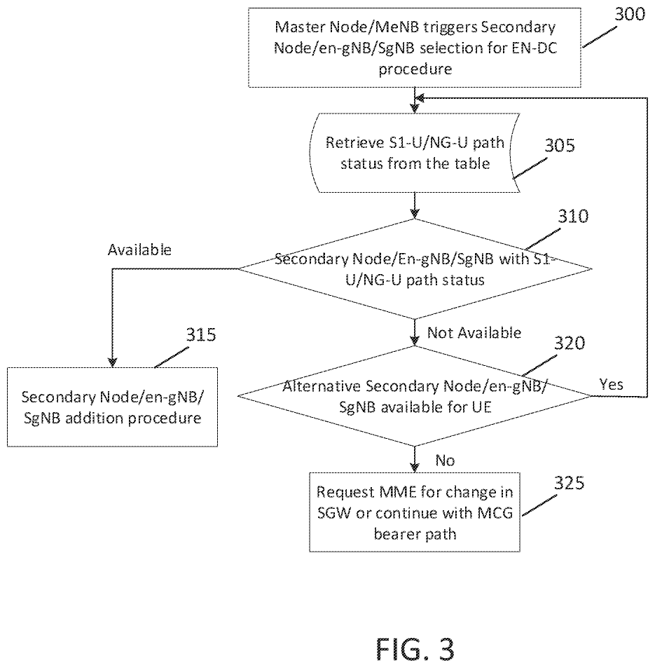

According to certain example embodiments, the master node/MeNB may include S1-U/NG-U path status as an additional criteria while selecting a secondary node/en-gNB/SgNB so that the secondary node/en-gNB/SgNB selected for SCG bearer may not cause data outage at the UE (see FIG. 3 with secondary node/en-gNB/SgNB selection logic with additional selection criteria). According to other example embodiments, the master node/MeNB may include S1-U/NG-U path status as additional criteria for rejecting an E-UTRAN radio access bearer (eRAB) establishment with a suitable cause for the MME to allocate another available SGW for the S1-U/NG-U bearer establishment to provide NR data throughput. In this example, the rejection logic is illustrated in the example of FIG. 3 discussed herein.

FIG. 3 illustrates an example of an secondary node/en-gNB/SgNB selection logic with additional selection criteria, according to certain example embodiments. As illustrated in FIG. 3, at 300, the master node/MeNB may trigger a secondary node/en-gNB/SgNB selection for an EN-DC procedure based on, for example, UE measurement information. At 305, the master node/MeNB may retrieve S1-U/NG-U status (i.e., GTP-U path status, whether there is a failure) from the information table 200 illustrated in FIG. 2. At 310, the master node/MeNB may determine whether the S1-U/NG-U path status of the secondary node/en-gNB/SgNB has been obtained. If the S1-U/NG-U path status has been obtained and is determined as having an “available” status, then, at 315, the master node/MeNB may initiate SgNB addition procedure to establish a connection between the MeNB and secondary node/en-gNB/SgNB. However, if it is determined that the S1-U/NG-U path status has an “unavailable” status, then, at 320, the master node/MeNB may determine whether an alternative secondary node/en-gNB/SgNB is available for the UE. If no, at 325, the master node/MeNB may request the MME to change the SGW or continue with the master cell group (MCG) bearer path. On the other hand, if an alternative secondary node/en-gNB/SgNB is available for the UE, the procedure may return to 305 where the master node/MeNB may retrieve the S1-U/NG-U path status of the alternative secondary node/en-gNB/SgNB from the table.

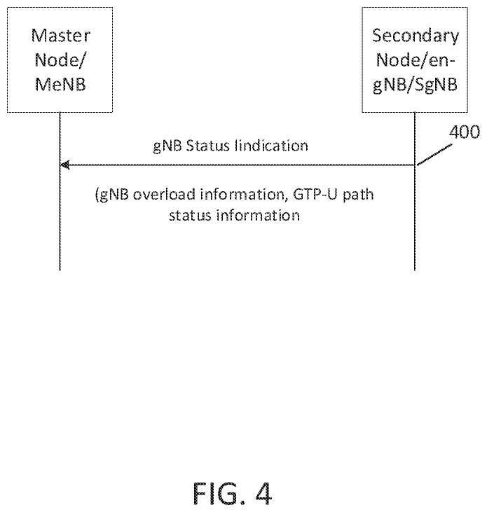

FIG. 4 illustrates an example gNB status indication procedure, according to certain example embodiments. At 400, the secondary node/en-gNB/SgNB may send a gNB status indication message to the master node/MeNB. According to certain example embodiments, the gNB status indication message may include gNB overload information and/or GTP-U path status information. Further, Table 1 lists several examples of the gNB status indication and their contents.

TABLE 1
gNB Status Indication

| IE/Group | | | IE type and | Semantics | | Assigned |
|---|---|---|---|---|---|---|
| Name | Presence | Range | reference | description | Criticality | Criticality |
| Message | M | | 9.2.13 | | YES | Ignore |
| Type | | | | | | |
| gNB | M | | ENUMERATED | | YES | ignore |
| Overload | | | (overloaded, | | | |
| Information | | | not-overloaded, | | | |
| | | | . . .) | | | |
| Interface | O | | 9.2.143 | | YES | Reject |
| Instance | | | | | | |
| Indication | | | | | | |
| S1-U Path | O | | | | YES | Ignore |
| Status | | | | | | |
| Information | | | | | | |

Table 2 lists certain examples of the S1-U/NG-U path information. According to certain example embodiments, this information element (IE) may provide information on the S1-U/NG-U supervision status. Further, Table 3 lists certain examples of the S1-U/NG- U interface events. According to certain example embodiments, the events upon which S1-U/NG-U path status may be communicated to the master node/MeNB may include those listed in Table 3. In addition, Table 4 lists certain examples of GTP-U status indication information. According to certain example embodiments, the GTP-U status indication information may be sent as a message by the secondary node/en-gNB/SgNB to indicate to the eNB its status of S1-U/NG-U path.

TABLE 2
S1-U/NG-U Path Status Information

| | | | IE type and | Semantics |
|---|---|---|---|---|
| IE/Group Name | Presence | Range | reference | description |
| S1U Path List | | 1 | | |
| >Path Item | | 1 . . . | | |
| | | <maxnoofS1uPath | | |
| >>SGW IP Address | M | | BIT STRING | SGW's Transport |
| | | | (1 . . . 160, . . .) | Layer Address |
| >>en-gNB IP Address | M | | BIT STRING | en-gNB's Transport |
| | | | (1 . . . 160, . . .) | Layer Address |
| >>Status | M | ENUMERATED | | |
| | | (Available, | | |
| | | NotAvailable, . . .) | | |

| Range bound | Explanation |
|---|---|
| maxnoofS1uPath | 255 |

TABLE 3
S1-U/NG-U Interface Events

| Event | Message | Direction | Status IE |
|---|---|---|---|
| S1-U Path Failure | GNB STATUS | En-gNB- | Not Available |
| | INDICATION | >MeNB | |
| S1-U Path Establishment | GNB STATUS | En-gNB- | Available |
| | INDICATION | >MeNB | |

TABLE 4
GTP-U Status Indication

| | | | | | | |
|---|---|---|---|---|---|---|
| IE/Group | | | IE type and | Semantics | | Assigned |
| Name | Presence | Range | reference | description | Criticality | Criticality |

| | | | |
|---|---|---|---|
| Message | M | YES | ignore |
| Type | | | |
| S1-U Path | M | YES | Ignore |
| Status | | | |
| Information | | | |

In certain example embodiments, on occurrence of events (see Table 3) over the S1-U/NG-U interface, the secondary node/en-gNB/SgNB may send a gNB status indication message (see Table 1) including optional S1-U/NG-U path status information IE (see Table 2) to indicate the S1-U/NG-U path status. Alternatively, in other example embodiments, the S1-U/NG-U status information may be communicated via a new message GTP-U status indication message (see Table 4).

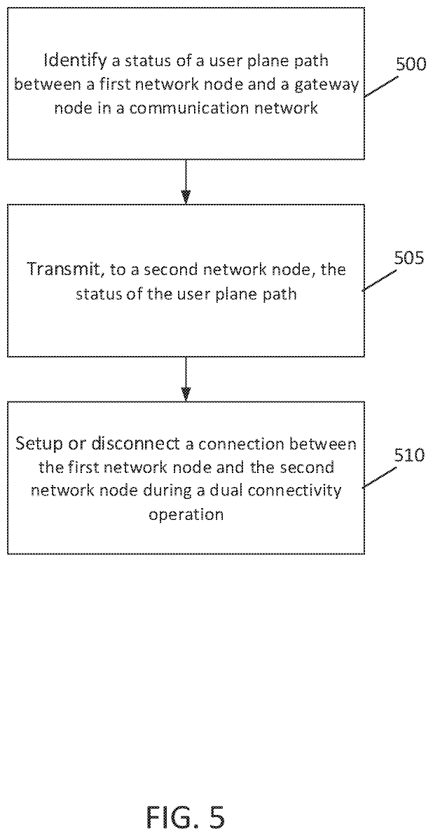

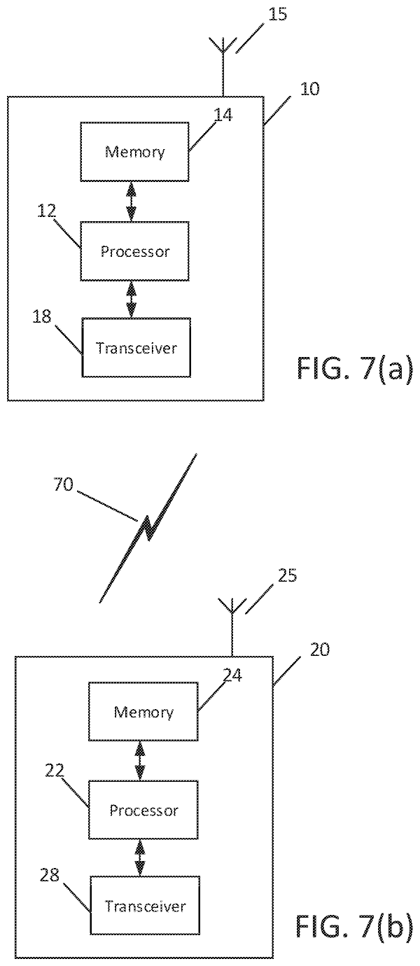

FIG. 5 illustrates an example flow diagram of a method, according to certain example embodiments. In an example embodiment, the method of FIG. 5 may be performed by a network entity, network node, or a group of multiple network elements in a 3GPP system, such as LTE or 5G-NR. For instance, in an example embodiment, the method of FIG. 5 may be performed by a secondary node/en-gNB/SgNB, for instance similar to apparatus 20 illustrated in FIG. 7(a).

According to certain example embodiments, the method of FIG. 5 may include, at 500, identifying a status of a user plane path between a first network node and a gateway node in a communication network. The method may also include, at 505, transmitting, to a second network node, the status of the user plane path. The method may further include, at 510, setting up or disconnecting a connection between the first network node and the second network node during a dual connectivity operation.

According to certain example embodiments, the status of the user plane path may include a failure status or recovered status. According to other example embodiments, the status may be transmitted to the second network node via a network node status indication message, a general packet radio service tunneling protocol for user plane (GTP-U) status indication message, or any other message between the first network node and the second network node. According to further example embodiments, the GTP-U status indication message may be a unicast message or a broadcast message.

In certain example embodiments, the network node status indication message may include GTP-U path status information along with overload information. In other example embodiments, the network node status indication message may include S1 user plane interface path status information to indicate an S1 user plane interface path status. In some example embodiments, the S1 user plane interface path status information may be communicated via a new GTP-U status indication message.

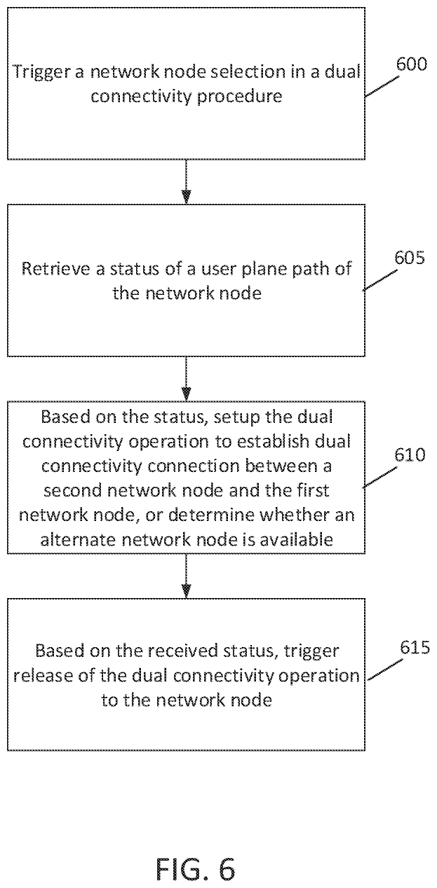

FIG. 6 illustrates an example flow diagram of another method, according to certain example embodiments. In an example embodiment, the method of FIG. 6 may be performed by a network entity, network node, or a group of multiple network elements in a 3GPP system, such as LTE or 5G-NR. For instance, in an example embodiment, the method of FIG. 6 may be performed by a master node/MeNB, for instance similar to apparatus 20 illustrated in FIG. 7(b).

According to certain example embodiments, the method of FIG. 6 may include, at 600, triggering a first network node selection in a dual connectivity operation. The method may also include, at 605, retrieving a status of a user plane path of the first network node. The method may further include, at 610, based on the received status, setting up the dual connectivity operation to establish a dual connectivity connection between a second network node and the first network node, or determining whether an alternate network node is available. The method may further include, at 615, based on the received status, triggering release of the dual connectivity operation to the first network node.

According to certain example embodiments, when it is determined that an alternate network node is not available, the method may also include requesting a mobility management entity for a different gateway node, or continuing a connection with a master cell group bearer path. According to other example embodiments, when it is determined that an alternative network node is available, the method may further include retrieving the status of the user plane path of the alternative network node. According to further example embodiments, the status may be retrieved via a network node status indication message, or a general packet radio service tunneling protocol for user plane (GTP-U) status indication message.

In certain example embodiments, the GTP-U status indication message may be a unicast message or a broadcast message. In some example embodiments, the network node status indication message may include GTP-U path status information along with overload information. In other example embodiments, the network node status indication message may include S1 user plane interface path status information to indicate an S1 user plane interface path status. In further example embodiments, the S1 user plane interface path status information is communicated via a new GTP-U status indication message.

FIG. 7(a) illustrates an apparatus 10 according to certain example embodiments. In certain example embodiments, apparatus 10 may be a node or element in a communications network or associated with such a network, such as a UE, mobile equipment (ME), mobile station, mobile device, stationary device, or other device. In other example embodiments, apparatus 10 may be an eNB/gNB. It should be noted that one of ordinary skill in the art would understand that apparatus 10 may include components or features not shown in FIG. 7(a).

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 7(a).

As illustrated in the example of FIG. 7(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 7(a), multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-6.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-6.

In some example embodiments, apparatus 10 may also include or be coupled to one or more antennas 15 for receiving a downlink signal and for transmitting via an uplink from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

FIG. 7(b) illustrates an apparatus 20 according to certain example embodiments. In certain example embodiments, the apparatus 20 may be a node or element in a communications network or associated with such a network, such as a base station, a Node B, an evolved Node B (eNB), 5G Node B or access point, next generation Node B (NG-NB or gNB), master node/MeNB, secondary node/en-gNB/SgNB and/or WLAN access point, associated with a radio access network (RAN), such as an LTE network, 5G or NR. It should be noted that one of ordinary skill in the art would understand that apparatus 20 may include components or features not shown in FIG. 7(b).

As illustrated in the example of FIG. 7(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7(b), multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-6.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-6.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to identify a status of a user plane path between the apparatus and a gateway node in a communication network. Apparatus 20 may also be controlled by memory 24 and processor 22 to transmit, to a network node, the status of the user plane path. Apparatus 20 may further be controlled by memory 24 and processor 22 to setup or disconnect a connection between the apparatus and the second network node during a dual connectivity operation.

In other example embodiments, apparatus 20 may be controlled by memory 24 and processor 22 to trigger a first network node selection in a dual connectivity operation. Apparatus 20 may also be controlled by memory 24 and processor 22 to retrieve a status of a user plane path of the first network node. Apparatus 20 may further be controlled by memory 24 and processor 22 to, based on the status, setup the dual connectivity operation to establish a dual connectivity connection between a second network node and the first network node, or determine whether an alternate network node is available. Apparatus 20 may also be controlled by memory 24 and processor 22 to, based on the received status, trigger release of the dual connectivity operation to the first network node.

Certain example embodiments may be directed to an apparatus that includes means for identifying a status of a user plane path between a first network node and a gateway node in a communication network. The apparatus may also include means for transmitting, to a second network node, the node of the user plane path. The apparatus may further include means for setting up or disconnecting a connection between the first network node and the second network node during a dual connectivity operation.

Other example embodiments may be directed to an apparatus that includes means for triggering a network node selection in a dual connectivity operation. The apparatus may also include means for retrieving a status of a user plane path of the network node. The apparatus may further include means for, based on the received status, setting up the dual connectivity operation to establish a dual connectivity connection between the network node and the apparatus, or determining whether an alternate network node is available. The apparatus may also include means for, based on the received status, triggering release of the dual connectivity operation to the network node.

Certain example embodiments described herein provide several technical improvements, enhancements, and/or advantages. In some example embodiments, it may be possible for the master node/MeNB to avoid selection of a GTP-U path experiencing path failure for an SgNB addition procedure. As such, the UE with dual connectivity capability may avoid having an SCG bearer established involving the path with the failure. In addition, the UE would be able to avoid experiencing data outage due to the broken link.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project

5G 5th Generation

5GCN 5G Core Network

eNB Enhanced Node B

EN-DC E-UTRA-NR Dual Connectivity

En-gNB E-UTRA-NR New Radio node

E-UTRA Evolved Universal Mobile Telecommunications System Terrestrial Radio Access

gNB 5G or Next Generation NodeB

GPRS General Packet Radio Service

GTP-U GPRS Tunneling Protocol for User Plane

MeNB Master eNB

NR New Radio

PDN Packet Data Network

SGW Serving Gateway

TEID Tunnel End Point Identifier

UE User Equipment

What is claimed is:

1. A method for a first network node, comprising:
identifying a status of a user plane path between the first network node and a gateway node in a communication network;
transmitting, to a second network node, the status of the user plane path; and
setting up or disconnecting a connection between the first network node and the second network node during a dual connectivity operation.

2. The method according to claim 1, wherein the status of the user plane path comprises a failure status or recovered status.

3. The method according to claims 1, wherein the status is transmitted to the second network node via a network node status indication message or a general packet radio service tunneling protocol for user plane status indication message.

4. The method according to claim 3, wherein the general packet radio service tunneling protocol for user plane status indication message is a unicast message or a broadcast message.

5. The method according to claim 3, wherein the network node status indication message comprises general packet radio service tunneling protocol for user plane path status information along with overload information.

6. The method according to claim 3, wherein the network node status indication message comprises S1 user plane interface path status information to indicate an S1 user plane interface path status.

7. The method according to claim 6, wherein the 51 user plane interface path status information is communicated via a new general packet radio service tunneling protocol for user plane status indication message.

8. An apparatus, comprising:
at least one processor; and
at least one memory comprising computer program code,
the at least one memory and the computer program code are configured, with the at least one processor, to cause the apparatus at least to:
identify a status of a user plane path between the apparatus and a gateway node in a communication network;
transmit, to a network node, the status of the user plane path; and
setup or disconnect a connection between the apparatus and the network node during a dual connectivity operation.

9. The apparatus according to claim 8, wherein the status of the user plane path comprises a failure status or recovered status.

10. The apparatus according to claim 8, wherein the status is transmitted to the network node via a network node status indication message or a general packet radio service tunneling protocol for user plane status indication message.

11. The apparatus according to claim 10, wherein the general packet radio service tunneling protocol for user plane status indication message is a unicast message or a broadcast message.

12. The apparatus according to claim 10, wherein the network node status indication message comprises general packet radio service tunneling protocol for user plane path status information along with overload information.

13. The apparatus according to claim 10, wherein the network node status indication message comprises S1 user plane interface path status information to indicate an S1 user plane interface path status.

14. The apparatus according to claim 13, wherein the 51 user plane interface path status information is communicated via a new general packet radio service tunneling protocol for user plane status indication message.

15. An apparatus, comprising:
at least one processor; and
at least one memory comprising computer program code,
the at least one memory and the computer program code are configured, with the at least one processor, to cause the apparatus at least to:
trigger a network node selection in a dual connectivity operation;
retrieve a status of a user plane path of the network node;
based on the received status,
setup the dual connectivity operation to establish a dual connectivity connection between the network node and the apparatus, or
determine whether an alternate network node is available; and
based on the received status, trigger release of the dual connectivity operation to the network node.

16. The apparatus according to claim 15, wherein when it is determined that an alternate network node is not available, the at least one memory and the computer program code are further configured, with the at least one processor, to cause the apparatus at least to:
request a mobility management entity for a different gateway node, or
continue a connection with a master cell group bearer path.

17. The apparatus according to claim 15, wherein when it is determined that an alternative network node is available, the at least one memory and the computer program code are further configured, with the at least one processor, to cause the apparatus at least to:
retrieve the status of the user plane path of the alternative network node.

18. The apparatus according to claim 15, wherein the status is retrieved via a network node status indication message, or a general packet radio service tunneling protocol for user plane status indication message.

19. The apparatus according to claim 18, wherein the general packet radio service tunneling protocol for user plane status indication message is a unicast message or a broadcast message.

20. The apparatus according to claim 18, wherein the network node status indication message comprises at least one of general packet radio service tunneling protocol for user plane path status information along with overload information and S1 user plane interface path status information to indicate an S1 user plane interface path status.
